(19) United States
(12) Patent Application Publication
(10) Pub. No.: US 2016/0348886 A1
(43) Pub. Date: Dec. 1, 2016

(54) ILLUMINATION DEVICE

(71) Applicant: Genius Electronic Optical Co., Ltd., Taichung City (TW)

(72) Inventor: Chih-Shen LIN, Taichung City (TW)

(73) Assignee: Genius Electronic Optical Co., Ltd.

(21) Appl. No.: 14/725,728

(22) Filed: May 29, 2015

(51) Int. Cl. F21V 29/74

(52) U.S. Cl. CPC F21V 29/74; F21Y 2101/02

(57) ABSTRACT

An illumination device includes a base, a light emitting unit disposed at one side of the base, and heat dissipation fins and a connecting fin which are in the form of laminated sheets and integrally formed at another side of the base. The illumination device can be formed when the illumination unit is fixed to the base. The base is an integral unitary structure integrally formed with the heat dissipation fins and the connecting fin, which not only produce a heat dissipation function, but also provide connection to the lamp post or the connecting member. Besides, the forming of the base requires no assembly operations, which simplifies the assembly and manufacturing process, while reducing manufacturing cost.

### BACKGROUND OF THE INVENTION

Field of the Invention

The present invention relates to an illumination device, and more particularly to a lightweight illumination device which is easy to assemble at a lower cost.

Description of the Prior Art

LED (light emitting diode) has been widely used in various illumination devices due to its advantages of low cost and high luminance. However, quick temperature rise during illumination requires that the illumination device must be equipped with a heat dissipation device LED in order to insure the service life and performance of the LED.

FIG. 1 shows that a conventional LED lamp 10 comprises a heat dissipation member 13 and a light emitting module 14 disposed between an upper housing 11 and a lower housing 12. To assemble the LED lamp 10 to a lamp post 15, the upper and lower housings 11, 12 must be provided with a lamp-post seat 16, via which the LED lamp 10 can be assembled to the lamp post 15, the whole structure is too complicated and uneconomic.

FIG. 2 shows another LED lamp 20, one side of the LED lamp 20 is provided for mounting of a light emitting module (not shown), and at another side of the LED lamp 20 is formed a lamp-post seat 22 which is a hollow circular pipe for insertion of a lamp post. The outer peripheral surface of the lamp-post seat 22 is provided with a plurality of fins 23 for heat dissipation purpose. However, the housing 21 must be provided with the hollow circular lamp-post seat 22 in order for the LED lamp 20 to be assembled to the lamp post, the whole structure is still too complicated.

The present invention has arisen to mitigate and/or obviate the afore-described disadvantages.

### SUMMARY OF THE INVENTION

The primary objective of the present invention is to provide a lightweight illumination device which is easy to assemble at a lower cost.

To achieve the above objective, an illumination device in accordance with the present invention comprises: a base and a light emitting unit. The base includes a plurality of heat dissipation fins and a connecting fin which are integrally formed at one side of a bottom of the base, the heat dissipation fins and the connecting fin are in the form of laminated sheets. Each of the heat dissipation fins and the connecting fin has one end integrally connected to the bottom, and another end of each of the heat dissipation fins and the connecting fin is a free end. A straight line distance from the bottom to the free end of the heat dissipation fins is defined as a heat-dissipation-fin height, and a straight line distance from the bottom to the free end of the connecting fin is defined as a connecting-fin height which is larger than the heat-dissipation-fin height. The light emitting unit is disposed at another side of the bottom.

An illumination device can be formed when the illumination unit is fixed to the base, the base is an integral unitary structure integrally formed with the heat dissipation fins and the connecting fin, which not only produce a heat dissipation function, but also provide connection to the lamp post or the connecting member. Besides, the forming of the base requires no assembly operations, which simplifies the assembly and manufacturing process, while reducing manufacturing cost.

### BRIEF DESCRIPTION OF THE DRAWINGS

FIG. 1 is an exploded view of a conventional LED illumination device;

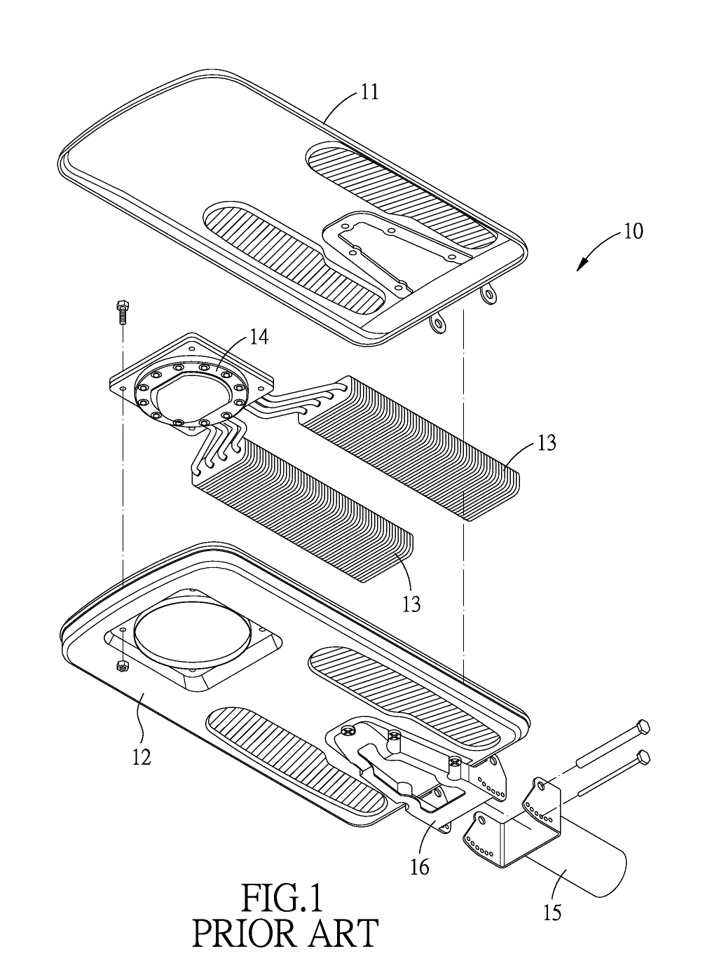

FIG. 2 shows another conventional LED illumination device;

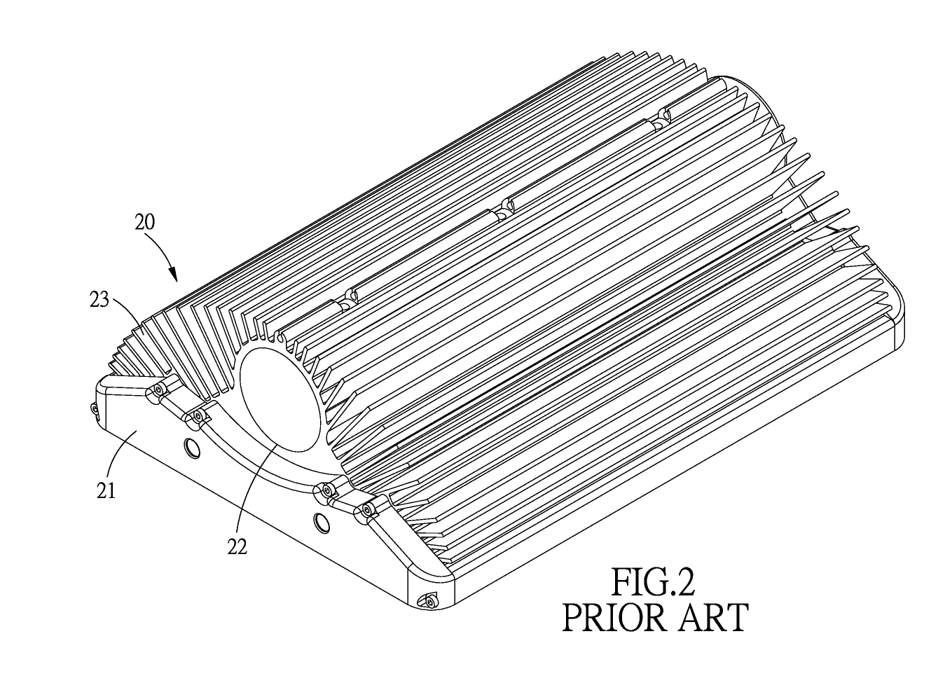

FIG. 3 is a perspective view of an illumination device in accordance with a preferred embodiment of the present invention;

FIG. 4 is a side view of the illumination device in accordance with the preferred embodiment of the present invention;

FIG. 5 is an illustrative view showing that the illumination device in accordance with the preferred embodiment of the present invention is assembled to a lamp post;

FIG. 6 is an exploded view of the illumination device in accordance with another embodiment of the present invention and the lamp post, wherein the connecting fin is located at a position different from FIG. 5;

FIG. 7 is an assembly view of FIG. 6;

FIG. 8 is a side view of FIG. 6;

FIG. 9 is a side view of the illumination device in accordance with another embodiment of the present invention, wherein the connecting portion is an elongated hole;

FIG. 10 is an exploded view of an illumination device in accordance with a further embodiment of the present invention and a lamp post;

FIG. 11 is an assembly view of FIG. 10;

FIG. 12 is an assembly side view of FIG. 10;

FIG. 13 is an exploded view of an illumination device in accordance with yet another embodiment of the present invention and a lamp post;

FIG. 14 is an assembly view of FIG. 13; and

FIG. 15 shows that the connecting member of an illumination device in accordance with the present invention is in the form of a handle.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

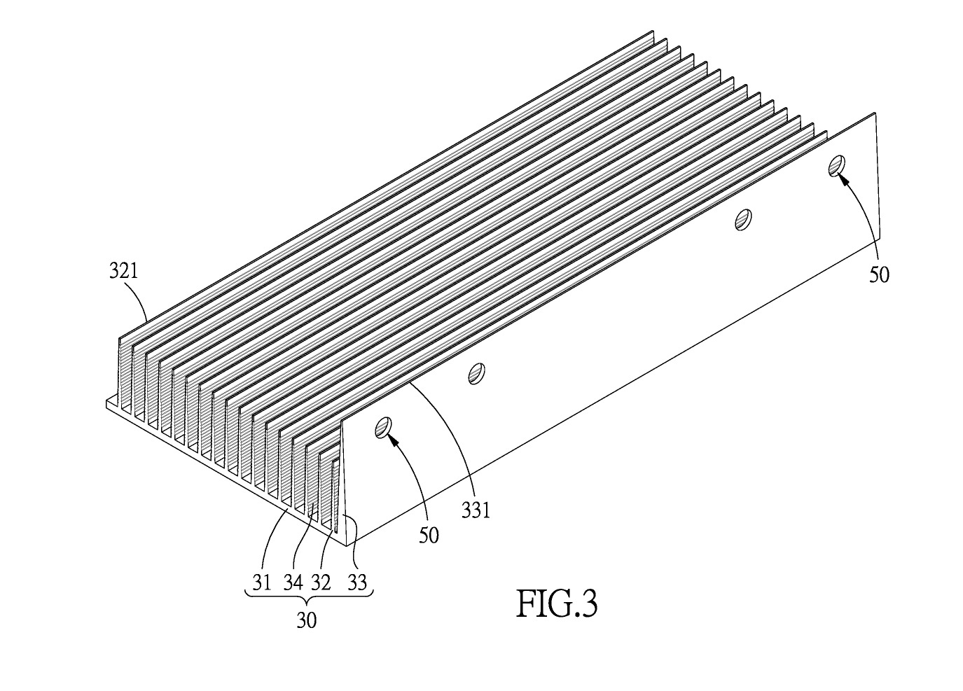

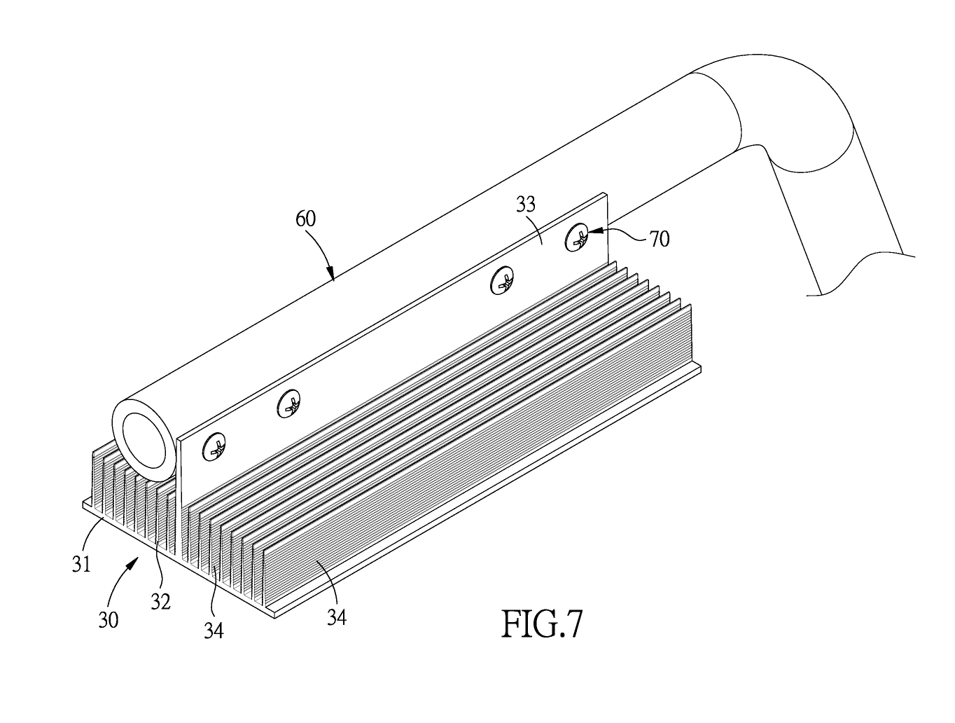

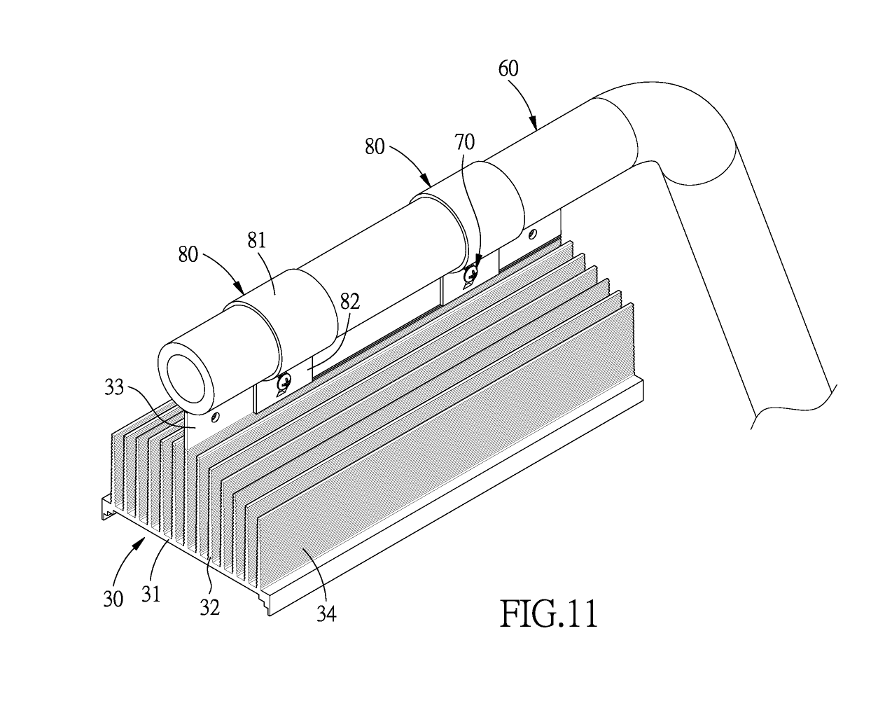

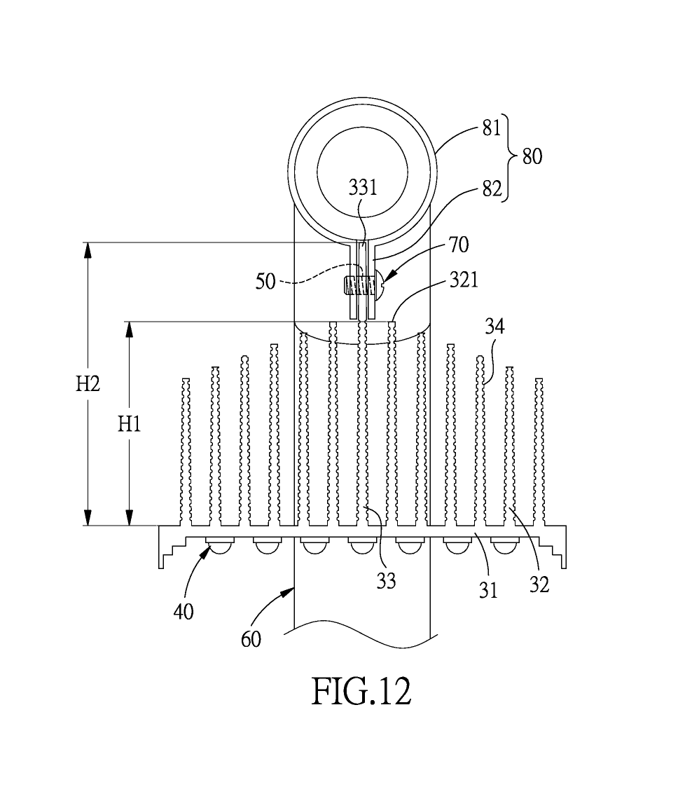

Referring to FIGS. 3-15, an illumination device in accordance with a preferred embodiment of the present invention comprises: a base 30 and a light emitting unit 40.

The base 30 is a unitary structure formed by aluminum extrusion, and includes a plurality of heat dissipation fins 32 and a connecting fin 33 which are integrally formed at one side of the bottom 31 of the base 30. The heat dissipation fins 32 and the connecting fin 33 are in the form of laminated sheets. The surfaces of the heat dissipation fins 32 and the connecting fin 33 are provided with convex or concave non-flat structures 34. Each of the heat dissipation fins 32 and the connecting fin 33 has one end integrally connected to the bottom 31, another end of each of the heat dissipation fins 32 is a free end 321, and another end of the connecting fin 33 is a free end 331. A shortest straight line distance from the bottom 31 to the free end 321 of each of the heat dissipation fins 32 is defined as a heat-dissipation-fin height H1 of the heat dissipation fins 32, a shortest straight line distance from the bottom 31 to the free end 331 of the connecting fin 33 is defined as a connecting-fin height H2, and H2>H1. In this embodiment, the bottom 31 is smooth and flat, and the heat dissipation fins 32 and the connecting fin 33 are spaced apart and parallel to one another. The bottom 31 is not limited to being a flat surface, and can be an arc-shaped structure. When the bottom 31 is arc-shaped, the heat dissipation fins 32 and the connecting fin 33 can be arranged in a radial pattern.

The light emitting unit 40 is disposed at another side of the bottom 31, and may in the form of LED light bars or a LED light board.

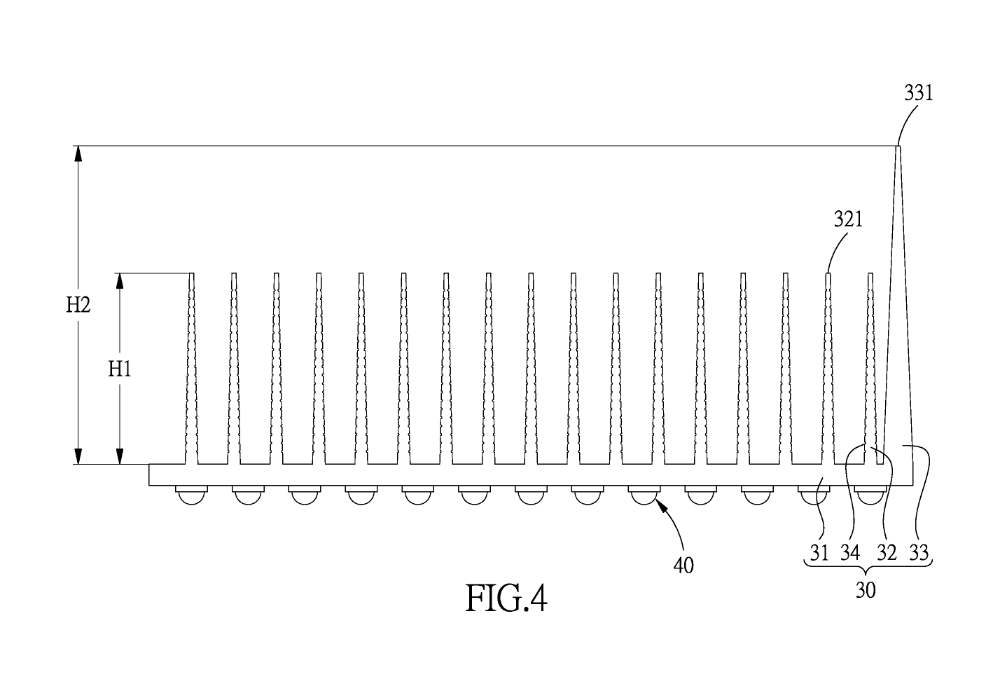

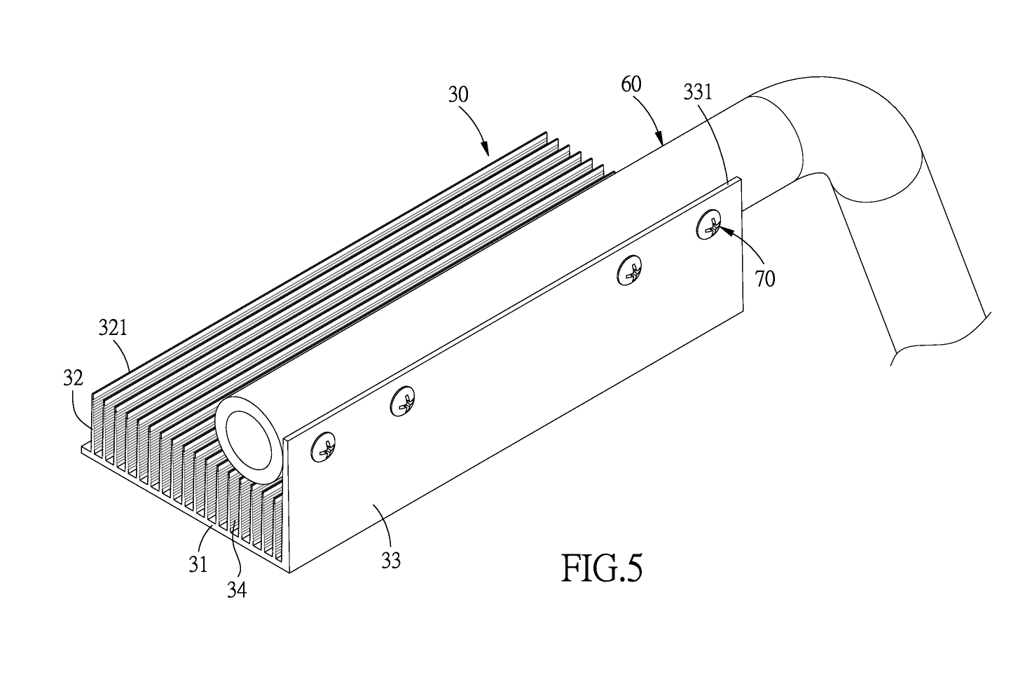

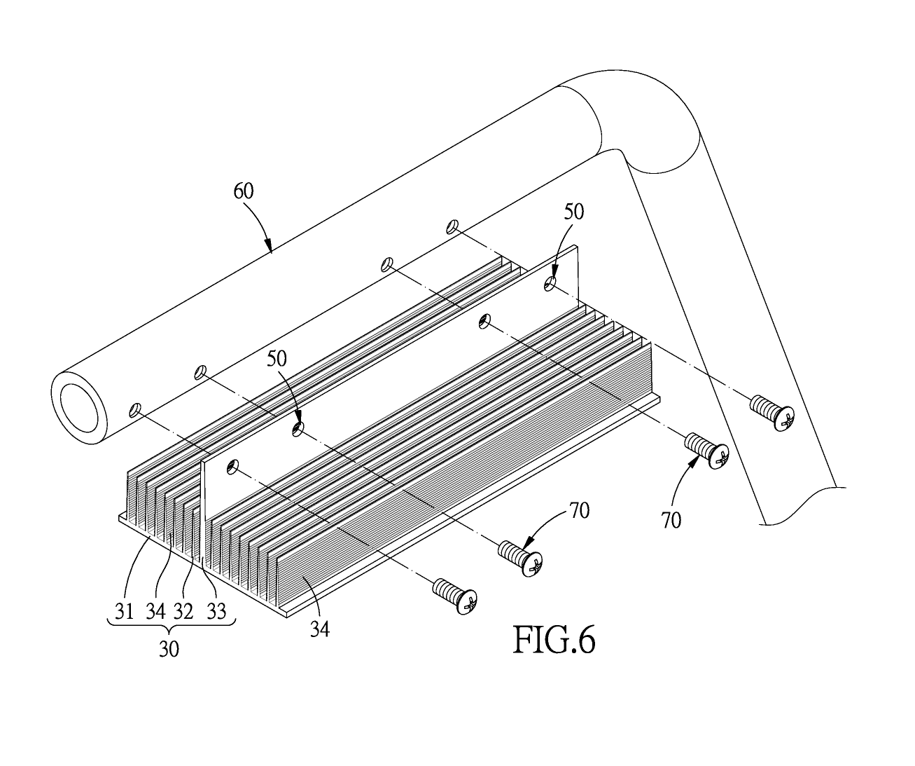

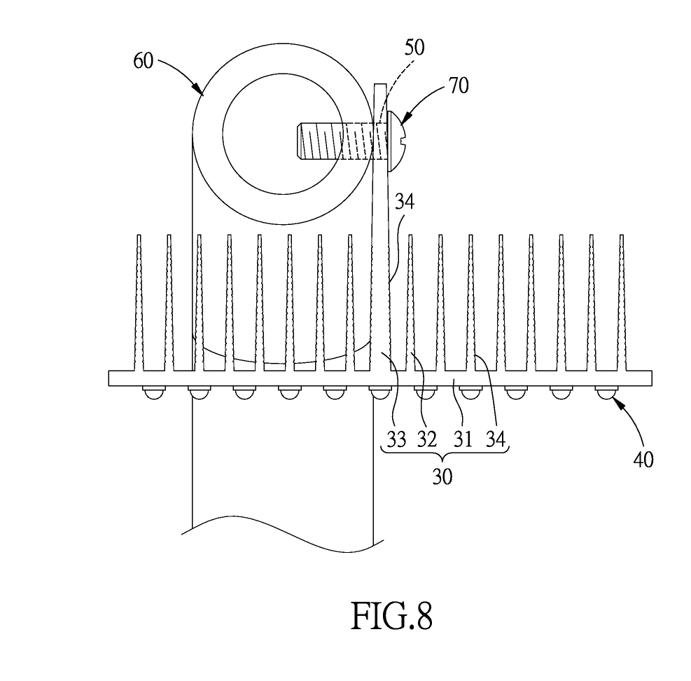

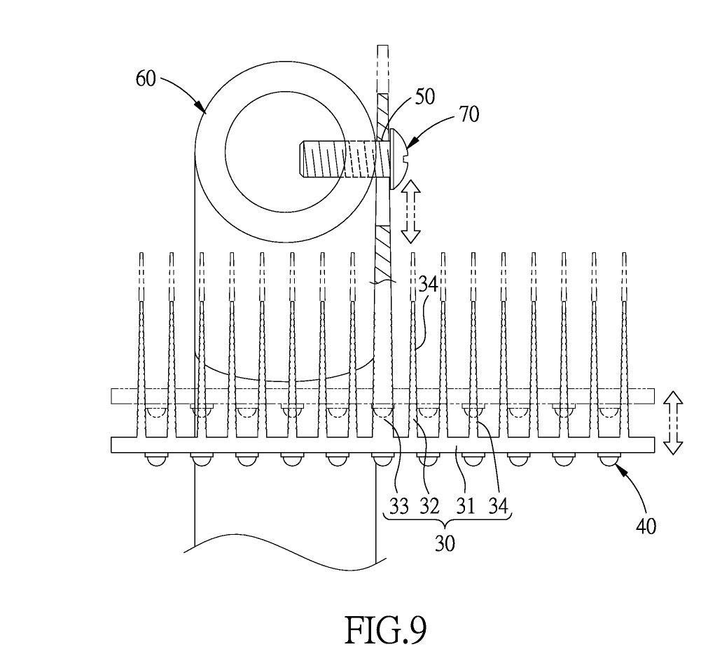

What mentioned are the basic structure of the illumination device in accordance with the present invention, and the illumination device can be used independently as shown in FIGS. 3 and 4, or can be used in combination with other devices as shown in FIGS. 5-8. As shown in FIGS. 6 and 8, the connecting fin 33 is formed with a plurality of connecting portions 50 via which the base 30 can be assembled to a lamp post 60. The connecting portions 50 as shown in FIGS. 5-8 are in the form of connecting holes, the connecting fin 33 is abutted against the lamp post 60, and then a plurality of fasteners 70 are inserted through the connecting portions 50 to fix the connecting fin 33 to the lamp post 60. As shown in FIGS. 6-8, another embodiment of the illumination device is similar to that shown in FIG. 5, the difference is that the connecting fin 33 as shown in FIG. 5 is located at the peripheral edge of the bottom 31, while the connecting fin 33 in FIGS. 6-8 is located among the heat dissipation fins 32. The location of the connecting fin 33 is not limited to the embodiments shown in the drawings, and can be adjusted as desired. Besides, the connecting portions 50 can also be in the form of slots, so that position can be adjusted after the illumination device is assembled onto the lamp post 60, as shown in FIG. 9.

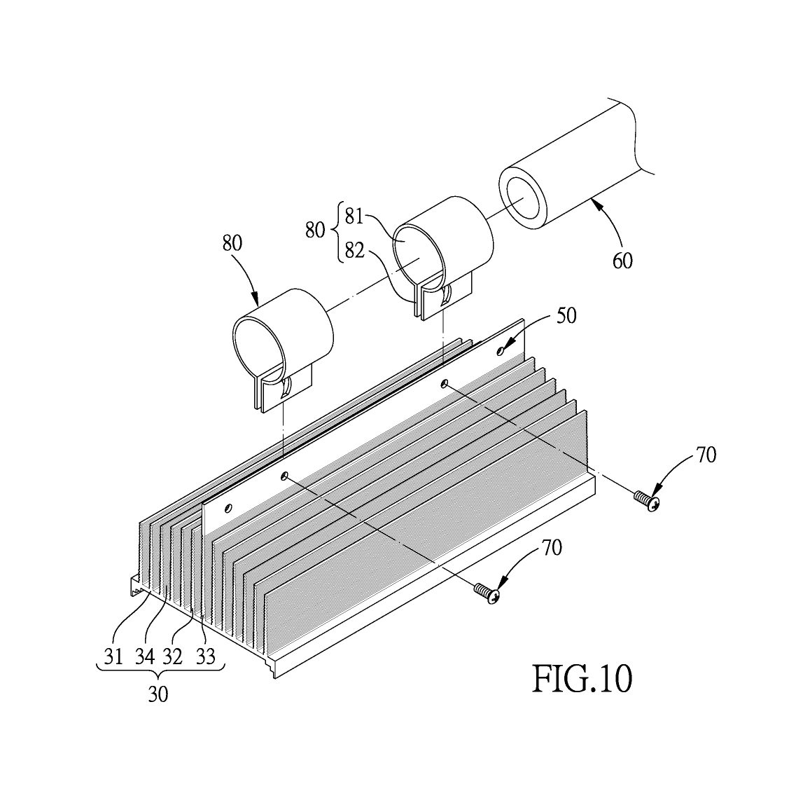

The heat dissipation fins 32 of the base 30 in the previous embodiment all have the same heat-dissipation-fin height H1, but they can also have different heat-dissipation-fin heights H1, as shown in FIGS. 10-15, and all the heat-dissipation-fin heights H1 are smaller than the connecting-fin height H2. Please refer to FIGS. 10-15 again, in addition to the fact that the connecting fin 33 of the base 30 is provided with a plurality of connecting portions 50, at least one connecting member 80 is used to fix the illumination device to the lamp post 60 or to carry the illumination device. In the embodiment shown in FIGS. 10-12, the illumination device is provided with two connecting members 80, and each of the connecting members 80 includes an annular portion 81 and two connecting legs 82 extending from two ends of the annular portion 81. The annular portion 81 is sleeved onto the lamp post 60, and the connecting legs 82 are clamped against the connecting fin 33. Each of the connecting legs 82 is formed with circular or elongated holes which are fixed to the connecting portion 50 by fasteners 70, so that the connecting legs 82 are fixed to the connecting fin 33, and the annular portion 81 is clamped against the lamp post 60.

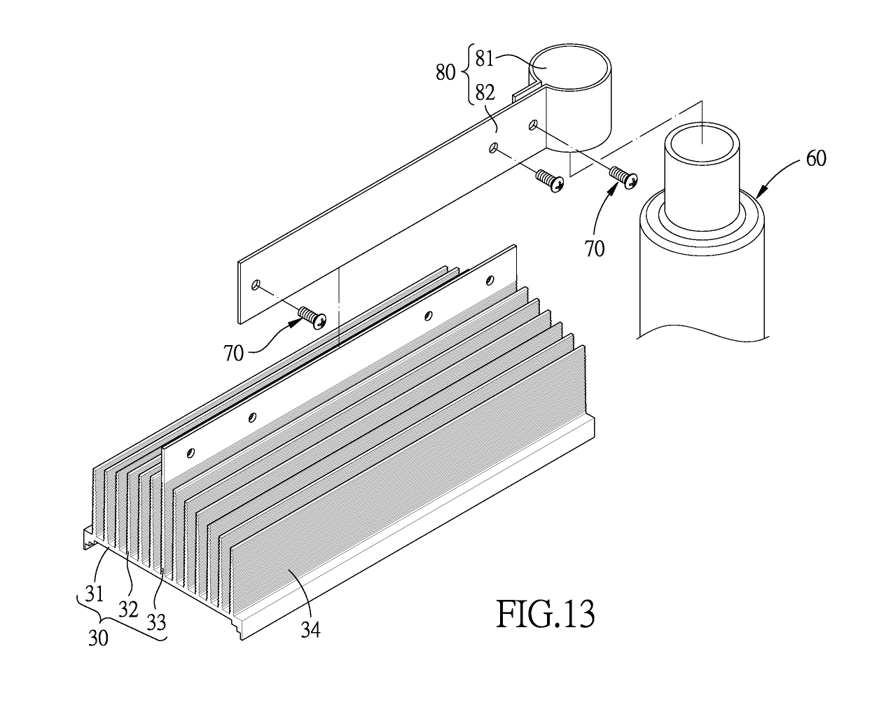

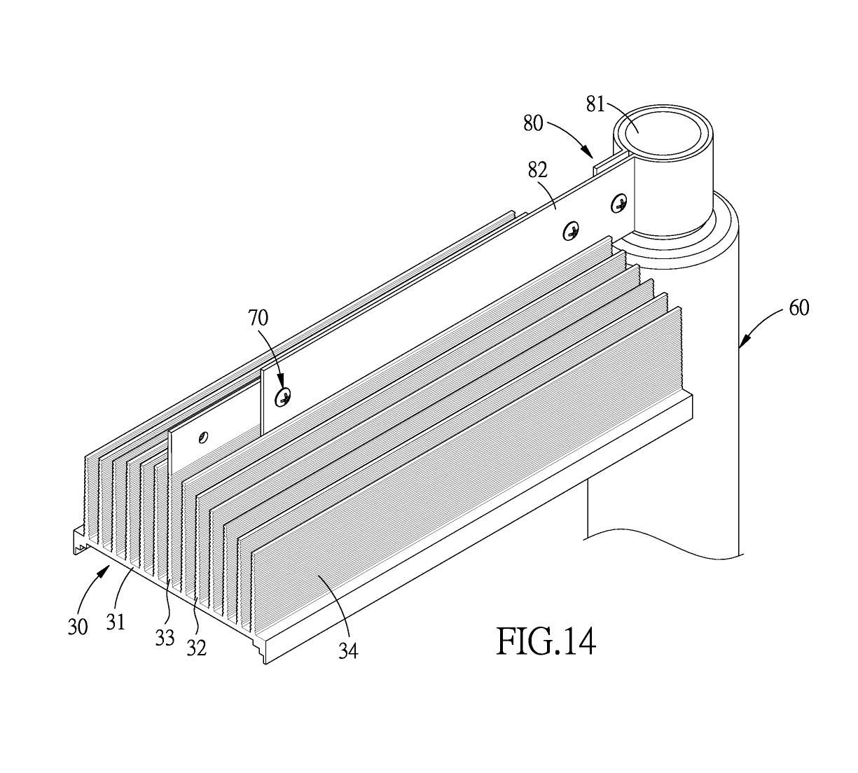

FIGS. 13 and 14 show another embodiment which is similar to the embodiment shown in FIGS. 10-12, the difference is that the direction of the annular portion 81 is different from that of the annular portion 81 shown in FIGS. 10-12, and the connecting member 80 is provided with a single connecting leg 82 to be fixed to the connecting fin 33. The connecting member 80 of this embodiment is designed for connection to a different type of lamp post.

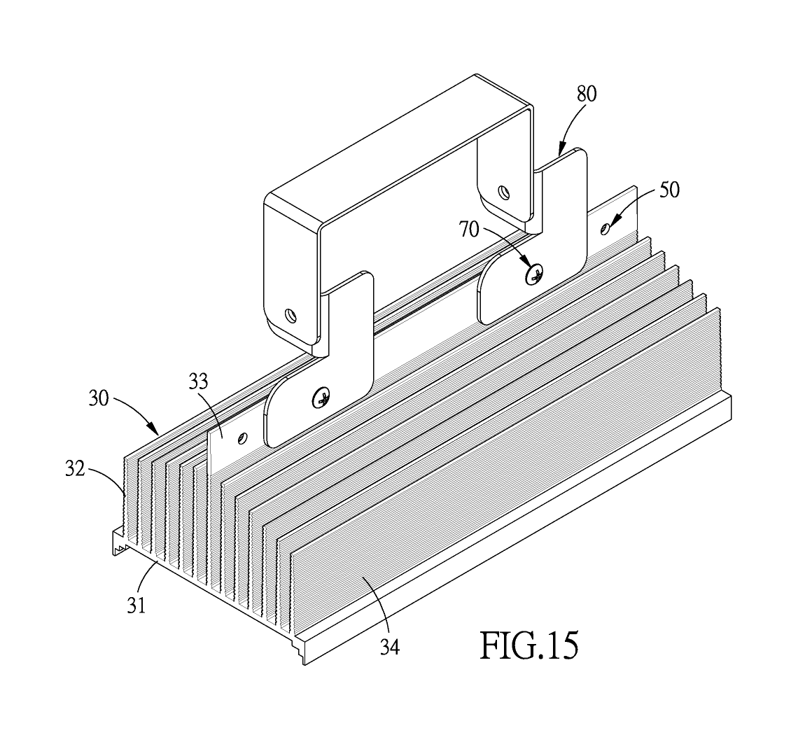

FIG. 15 shows a further embodiment, wherein the connecting member 80 is in the form of a handle which is fixed to the base 30, so that the illumination device can be used as a hand-held device.

It is learned from the above description that an illumination device can be formed when the light emitting unit 40 is fixed to the base 30, the base 30 is an integral unitary structure integrally formed with the heat dissipation fins 32 and the connecting fin 33, which not only produce a heat dissipation function, but also provide connection to the lamp post 60 or the connecting member 80. The forming of the base 30 requires no assembly operations, which simplifies the assembly and manufacturing process, while reducing manufacturing cost.

The heat dissipation fins 32 and the connecting fin 33 of the base 30 are in the form of laminated sheets, which not only reduces the weight and cost of the base 30, but also provides better heat dissipation performance. Besides, the non-flat structures 34 formed on the surface of the heat dissipation fins 32 and the connecting fin 33 can improve heat dissipation performance by increasing the area of heat dissipation surface.

When the connecting fin 33 is used in combination with different types of connecting members 80, the base 30 can be adapted to different needs, so that the applicability of the illumination device of the present invention is substantially enhanced to add value to the product.

While we have shown and described various embodiments in accordance with the present invention, it is clear to those skilled in the art that further embodiments may be made without departing from the scope of the present invention.

What is claimed is:

1. An illumination device comprising:
a base including a plurality of heat dissipation fins and a connecting fin which are integrally formed at one side of a bottom of the base, the heat dissipation fins and the connecting fin being in the form of laminated sheets, each of the heat dissipation fins and the connecting fin having one end integrally connected to the bottom, another end of each of the heat dissipation fins and the connecting fin being a free end, a straight line distance from the bottom to the free end of the heat dissipation fins being defined as a heat-dissipation-fin height, a straight line distance from the bottom to the free end of the connecting fin being defined as a connecting-fin height which is larger than the heat-dissipation-fin height; and
a light emitting unit disposed at another side of the bottom.

2. The illumination device as claimed in claim 1, wherein the bottom is flat or arc-shaped.

3. The illumination device as claimed in claim 1, wherein the heat dissipation fins and the connecting fin are spaced apart and parallel to one another, or arranged in a radial pattern.

4. The illumination device as claimed in claim 1, wherein surfaces of the heat dissipation fins and the connecting fin are provided with convex or concave non-flat structures.

5. The illumination device as claimed in claim 1, wherein the connecting fin is provided with a connecting portion for connection to a lamp post.

6. The illumination device as claimed in claim 1, wherein the connecting fin is provided with a connection portion and a connecting member for connection to a lamp post.

7. The illumination device as claimed in claim 6, wherein the connecting member includes an annular portion and two connecting legs extending from two ends of the annular portion, the annular portion is sleeved onto the lamp post, and the connecting legs are clamped against the connecting fin.

8. The illumination device as claimed in claim 7, wherein the connecting leg is formed with circular or elongated holes.

9. The illumination device as claimed in claim 1, wherein the connecting fin is provided with a connecting portion for connection to a connecting member in the form of a handle.

10. The illumination device as claimed in claim 1, wherein the light emitting unit is in the form of light emitting diode light bars or a light emitting diode light board.

11. The illumination device as claimed in claim 5, wherein the connection portion is in the form of plural connecting holes.

12. The illumination device as claimed in claim 6, wherein the connecting portion is in the form of plural connecting holes.

13. The illumination device as claimed in claim 9, wherein the connecting portion is in the form of plural connecting holes.

14. The illumination device as claimed in claim 1, wherein the base is a unitary structure formed by aluminum extrusion.
